(19) United States
(12) Patent Application Publication
(10) Pub. No.: US 2014/0307150 A1
(43) Pub. Date: Oct. 16, 2014

(54) IMAGING DEVICE, FOCUS ADJUSTMENT SYSTEM, FOCUS INSTRUCTION DEVICE, AND FOCUS ADJUSTMENT METHOD

(71) Applicant: Olympus Corporation, Tokyo (JP)

(72) Inventors: Akihiko SAKAMOTO, Yokohama-shi (JP); Yasuhiro HASEGAWA, Hanno-shi (JP)

(73) Assignee: Olympus Corporation, Tokyo (JP)

(21) Appl. No.: 14/229,214

(22) Filed: Mar. 28, 2014

(30) Foreign Application Priority Data
Apr. 11, 2013 (JP) 2013-082925

(51) Int. Cl. H04N 5/232

(52) U.S. Cl. CPC H04N 5/23212
USPC 348/349

(57) ABSTRACT

An imaging device includes: an imaging unit configured to repeat image capturing and output captured images in sequence; a wireless communication unit configured to wirelessly transmit the captured images in sequence and wirelessly receive a first information specifying one of the captured images wirelessly transmitted in sequence and a second information indicating a specific position or region in the captured image specified by the first information; a subject detection unit configured to detect a subject present at the position or region indicated by the second information in the captured image specified by the first information, from the captured image newly captured by the imaging unit; and a focus adjustment unit configured to adjust focus so that the subject detected by the subject detection unit is in focus.

### BACKGROUND OF THE INVENTION

1. Field of the Invention

The present invention relates to a technology for facilitating designation of a subject to be focused on when imaging is performed.

Priority is claimed on Japanese Patent Application No. 2013-082925, filed Apr. 11, 2013, the content of which is incorporated herein by reference.

2. Description of Related Art

A technology for designating a subject located at any position on a screen and desired to be focused on while viewing a real-time video is disclosed in Japanese Unexamined Patent Application, First Publication No. H11-142719. The real-time video refers to a video that is captured by an imaging unit and is displayed in sequence on a display unit and refers to a video that includes captured images (frame images) acquired for each frame period which is a period in which the captured images are acquired.

In the technology disclosed in Japanese Unexamined Patent Application, First Publication No. H11-142719, a pressure-sensitive panel with a same shape as a liquid crystal display panel is installed to be superimposed on the liquid crystal display panel. According to this configuration, when a user presses a position at which focus is desired while viewing a real-time video, the pressure-sensitive panel detects a pressing manipulation and a pressed position on the pressure-sensitive panel. As a result, an imaging device is controlled such that a position based on the pressed position information on the pressure-sensitive panel is focused on using the pressing manipulation as a trigger.

### SUMMARY OF THE INVENTION

According to a first aspect of the present invention, there is provided an imaging device including: an imaging unit configured to repeat image capturing and output captured images in sequence; a wireless communication unit configured to wirelessly transmit the captured images in sequence and wirelessly receive a first information specifying one of the captured images wirelessly transmitted in sequence and a second information indicating a specific position or region in the captured image specified by the first information; a subject detection unit configured to detect a subject present at the position or region indicated by the second information in the captured image specified by the first information, from the captured image newly captured by the imaging unit; and a focus adjustment unit configured to adjust focus so that the subject detected by the subject detection unit is in focus.

According to a second aspect of the present invention, in the imaging device according to the first aspect, the subject detection unit may specify one of the captured images as a second captured image specified by the first information, excluding a first captured image which is the latest captured image, among the captured images already captured by the imaging unit when the first information and the second information are received. The subject detection unit may detect the subject present at the position or region indicated by the second information in the specified second captured image, subsequently detect the subject detected from the second captured image in a third captured image which is captured between the second captured image and the first captured image, and detect the subject detected from the third captured image in the first captured image. The focus adjustment unit may adjust the focus so that the subject detected from the first captured image by the subject detection unit is in focus.

According to a third aspect of the present invention, in the imaging device according to the second aspect, the subject detection unit may detect the subject in a sequential order in a plurality of the third captured images which are captured between the second captured image and the first captured image.

According to a fourth aspect of the present invention, in the imaging device according to the third aspect, the subject detection unit may detect the subject in a sequential order in all of the third captured images captured between the second captured image and the first captured image.

According to a fifth aspect of the present invention, in the imaging device according to the fourth aspect, the subject detection unit may skip some captured images when proceeding among all of the third captured images captured from the second captured image to the first captured image and detect the subject in a sequential order in the third captured images excluding the skipped third captured images.

According to a sixth aspect of the present invention, in the imaging device according to the fifth aspect, when the subject detection unit detects the subject in the third captured images in a sequential order, the subject detection unit may calculate a movement amount of the subject between the captured images in which the subject is detected and decide a number of the captured images skipped when proceeding from the captured image in which the subject is already detected to the captured image in which the subject is subsequently detected based on the movement amount.

According to a seventh aspect of the present invention, in the imaging device according to the first aspect, the subject detection unit may specify any of the captured images as a second captured image specified by the first information, excluding a first captured image which is the latest captured image, among the captured images already captured by the imaging unit when the first information and the second information are received. The subject detection unit may detect the subject present at the position or region indicated by the second information in the specified second captured image and may subsequently detect the subject detected from the second captured image in the first captured image. The focus adjustment unit may adjust the focus so that the subject detected from the first captured image by the subject detection unit is in focus.

According to an eighth aspect of the present invention, in the imaging device according to the first aspect, the wireless communication unit may wirelessly receive a movement vector of a subject present at the specific position or region indicated by the second information. The subject detection unit may estimate, by using the movement vector, a position or region in the captured image newly captured by the imaging unit, the estimated position or region corresponding to the specific position or region indicated by the second information in the captured image specified by the first information. The subject detection unit may detect the subject present in the estimated position or region.

According to a ninth aspect of the present invention, in the imaging device according to the eighth aspect, the subject detection unit may calculate a difference amount between frame periods of the captured image specified by the first information and the captured image newly captured by the imaging unit. The subject detection unit may estimate, by using the movement vector and the difference amount between the frame periods, the position or region in the captured image newly captured by the imaging unit, the estimated position or region corresponding to the specific position or region indicated by the second information in the captured image specified by the first information. The subject detection unit may detect the subject present in the estimated position or region.

According to a tenth aspect of the present invention, in the imaging device according to any one of the first to ninth aspects, the wireless communication unit may wirelessly receive, as the second information, coordinates information indicating the specific position or region in the captured image specified by the first information.

According to an eleventh aspect of the present invention, in the imaging device according to any one of the first to ninth aspects, the wireless communication unit may wirelessly receive, as the second information, image information regarding the specific position or region in the captured image specified by the first information.

According to a twelfth aspect of the present invention, in the imaging device according to the eleventh aspect, the image information may be a contracted image of the specific position or region in the captured image specified by the first information.

According to a thirteenth aspect of the present invention, there is provided a focus adjustment system including: an imaging unit configured to repeat image capturing and output captured images in sequence; a first wireless communication unit configured to wirelessly transmit the captured images in sequence; a second wireless communication unit configured to wirelessly receive the captured images wirelessly transmitted in sequence from the first wireless communication unit in sequence; and a specifying unit configured to specify one of the captured images wirelessly received in sequence by the second wireless communication unit and specify a specific position or region in the specified captured image. The second wireless communication unit wirelessly transmits first information indicating the captured image specified by the specifying unit and second information indicating the position or region specified by the specifying unit. The first wireless communication unit wirelessly receives the first information and the second information. The focus adjustment system further includes: a subject detection unit configured to detect a subject present at the position or region indicated by the second information in the captured image specified by the first information, from the captured image newly captured by the imaging unit; and a focus adjustment unit configured to adjust focus so that the subject detected by the subject detection unit is in focus.

According to a fourteenth aspect of the present invention, in the imaging focus adjustment system according to the thirteenth aspect, the second wireless communication unit may transmit a frame number as the first information.

According to a fifteenth aspect of the present invention, in the imaging focus adjustment system according to the thirteenth or fourteenth aspect, the second wireless communication unit may transmit, as the second information, coordinates information indicating the position or region specified by the specifying unit or image information regarding the position or region.

According to a sixteenth aspect of the present invention, in the imaging focus adjustment system according to the fifteenth aspect, the second wireless communication unit may transmit, as the second information, a movement vector of the subject present at the position or region in addition to the coordinates information and the image information.

According to a seventeenth aspect of the present invention, a focus instruction device is used in a focus adjustment system including an imaging unit configured to repeat image capturing and output captured images in sequence, a first wireless communication unit configured to wirelessly transmit the captured images in sequence, a second wireless communication unit configured to wirelessly receive the captured images wirelessly transmitted in sequence from the first wireless communication unit in sequence, and a specifying unit configured to specify one of the captured images wirelessly received in sequence by the second wireless communication unit and specify a specific position or region in the specified captured image. The second wireless communication unit wirelessly transmits first information indicating the captured image specified by the specifying unit and second information indicating the position or region specified by the specifying unit. The first wireless communication unit wirelessly receives the first information and the second information. The focus adjustment system further includes a subject detection unit configured to detect a subject present at the position or region indicated by the second information in the captured image specified by the first information, from the captured image newly captured by the imaging unit, and a focus adjustment unit configured to adjust the focus so that the subject detected by the subject detection unit is in focus. The focus instruction device includes the second wireless communication unit and the specifying unit.

According to an eighteenth aspect of the present invention, a focus instruction device is provided that the focus instruction device includes: a wireless communication unit configured to wirelessly receive captured images, repeatedly captured by an imaging device and wirelessly transmitted in sequence, in sequence; a specifying unit configured to specify one of the captured images wirelessly received in sequence by the wireless communication unit and specify a specific position or region in the specified captured image. The wireless communication unit wirelessly transmits, to the imaging device, first information indicating the captured image specified by the specifying unit and second information indicating the position or region specified by the specifying unit.

According to a nineteenth aspect of the present invention, a focus adjustment method is provided that the focus adjustment method includes steps of: repeating image capturing and outputting captured images in sequence using an imaging unit; wirelessly transmitting the captured images in sequence using a first wireless communication unit; wirelessly receiving the captured images wirelessly transmitted in sequence from the first wireless communication unit in sequence using a second wireless communication unit; specifying one of the captured images wirelessly received in sequence using the second wireless communication unit and specifying a specific position or region in the specified captured image using a specifying unit; wirelessly transmitting first information indicating the captured image specified by the specifying unit and second information indicating the position or region specified by the specifying unit, using the second wireless communication unit; wirelessly receiving the first information and the second information using the first wireless communication unit; detecting a subject present at the position or region indicated by the second information in the captured image specified by the first information, from the captured image newly captured by the imaging unit, using a subject detection unit; and adjusting the focus so that the subject detected by the subject detection unit is in focus, using a focus adjustment unit.

According to twentieth aspect of the present invention, a computer program product storing a program is provided that the computer program causes a computer to perform steps of: repeating image capturing and outputting captured images in sequence using an imaging unit; wirelessly transmitting the captured images in sequence using a wireless communication unit; wirelessly receiving first information specifying one of the captured images wirelessly transmitted in sequence and second information indicating a specific position or region in the captured image specified by the first information, using the wireless communication unit; detecting a subject present at the position or region indicated by the second information in the captured image specified by the first information, from the captured image newly captured by the imaging unit; and adjusting the focus so that the subject detected by the subject detection unit is in focus.

According to a twenty-first aspect of the present invention, a computer program product storing a program is provided that the program causes a computer of a focus instruction device used in a focus adjustment system which includes an imaging unit configured to repeat image capturing and output captured images in sequence, a first wireless communication unit configured to wirelessly transmit the captured images in sequence, a second wireless communication unit configured to wirelessly receive the captured images wirelessly transmitted in sequence from the first wireless communication unit in sequence, and a specifying unit configured to specify one of the captured images wirelessly received in sequence by the second wireless communication unit and specify a specific position or region in the specified captured image, in which the second wireless communication unit wirelessly transmits first information indicating the captured image specified by the specifying unit and second information indicating the position or region specified by the specifying unit, in which the first wireless communication unit wirelessly receives the first information and the second information, and which further includes a subject detection unit configured to detect a subject present at the position or region indicated by the second information in the captured image specified by the first information, from the captured image newly captured by the imaging unit, and a focus adjustment unit configured to adjust focus so that the subject detected by the subject detection unit is in focus. The program causes the computer to perform steps of: wirelessly receiving the captured images wirelessly transmitted in sequence from the first wireless communication unit in sequence using the second wireless communication unit; specifying one of the captured images wirelessly received in sequence using the second wireless communication unit and specifying the specific position or region in the specified captured image; and wirelessly transmitting the first information indicating the specified captured image and the second information indicating the specified position or region using the second wireless communication unit.

According to a twenty-second aspect of the present invention, there is provided a computer program product storing a program causing a computer to perform steps of: wirelessly receiving, in a sequential order using a wireless communication unit, captured images repeatedly captured by an imaging device and wirelessly transmitted in sequence; specifying one of the captured images wirelessly received in sequence using the wireless communication unit and specifying a specific position or region in the specified captured image; and wirelessly transmitting first information indicating the specified captured image and second information indicating the specified position or region to the imaging device using the wireless communication unit.

### BRIEF DESCRIPTION OF THE DRAWINGS

FIG. 1A is a reference diagram illustrating a flow of all of the operations in a focus adjustment system according to a first embodiment of the present invention.

FIG. 1B is a reference diagram illustrating the flow of all of the operations in the focus adjustment system according to the first embodiment of the present invention.

FIG. 1C is a reference diagram illustrating the flow of all of the operations in the focus adjustment system according to the first embodiment of the present invention.

FIG. 2 is a block diagram illustrating the constitution of an imaging device according to the first embodiment of the present invention.

FIG. 3 is a flowchart illustrating an operation of the imaging device according to the first embodiment of the present invention.

FIG. 4 is a reference diagram illustrating a method of storing a real-time video and captured-image specifying information according to the first embodiment of the present invention.

FIG. 5 is a flowchart illustrating an operation of the imaging device according to the first embodiment of the present invention.

FIG. 6 is a flowchart illustrating an operation of the imaging device according to the first embodiment of the present invention.

FIG. 7 is a block diagram illustrating the constitution of a focus instruction device according to a second embodiment of the present invention.

FIG. 8 is a flowchart illustrating an operation of the focus instruction device according to the second embodiment of the present invention.

FIG. 9 is a flowchart illustrating an operation of the focus instruction device according to the second embodiment of the present invention.

FIG. 10 is a flowchart illustrating an operation of an imaging device according to a modified example of each embodiment of the present invention.

FIG. 11 is a flowchart illustrating an operation of an imaging device according to a modified example of each embodiment of the present invention.

FIG. 12 is a flowchart illustrating an operation of an imaging device according to a modified example of each embodiment of the present invention.

FIG. 13 is a block diagram illustrating the constitution of a focus instruction device according to a modified example of the second embodiment of the present invention.

FIG. 14A is a reference diagram illustrating a flow of all of the operations of a focus adjustment system according to a modified example of the second embodiment of the present invention.

FIG. 14B is a reference diagram illustrating the flow of all of the operations of the focus adjustment system according to the modified example of the second embodiment of the present invention.

FIG. 14C is a reference diagram illustrating the flow of all of the operations of the focus adjustment system according to the modified example of the second embodiment of the present invention.

FIG. 15 is a block diagram illustrating the constitution of the focus instruction device according to a modified example of the second embodiment of the present invention.

FIG. 16 is a flowchart illustrating an operation of the focus instruction device according to a modified example of the second embodiment of the present invention.

FIG. 17 is a flowchart illustrating an operation of the focus instruction device according to a modified example of the second embodiment of the present invention.

FIG. 18 is a flowchart illustrating an operation of the focus instruction device according to a modified example of the second embodiment of the present invention.

### DETAILED DESCRIPTION OF THE INVENTION

Hereinafter, embodiments of the present invention will be described with reference to the drawings.

### First Embodiment

First, a first embodiment of the present invention will be described. A focus adjustment system according to the present embodiment is an example of a system in which a time lag between imaging of a real-time video by an imaging device and display of the real-time video by a focus instruction device is large. According to the focus adjustment system of the present embodiment, the focus instruction device controls the imaging device so as to cause the imaging device to focus on a subject designated by the focus instruction device, based on a captured-image specifying information (first information), a region specifying information (second information) received from the focus instruction device by the imaging device, and a real-time video, a captured-image specifying information stored in the imaging device at the time of transmission of the real-time video.

The captured-image specifying information according to the present embodiment is information specifying any of the captured images configuring a real-time video wirelessly transmitted from the imaging device. Specifically, the captured-image specifying information is a unique identifier that is added in sequence to the real-time video when the imaging device acquires the real-time video. For example, the captured-image specifying information is a frame number of the real-time video. The captured-image specifying information may be information which is not added to the real-time video, e.g., may be the real-time video itself, and is not limited to the frame number as long as the captured-image specifying information is unique information that can specify a captured image.

The region specifying information according to the present embodiment is information configured to notify the imaging device of a selected subject. The region specifying information is transmitted to the imaging device when the focus instruction device selects a subject. Specifically, the region specifying information is information that indicates the position or region of a specific subject in a captured image specified by the captured-image specifying information. For example, the region specifying information is information that includes at least one of coordinates in a real-time video selected by the user, a face image of a subject, and a movement vector in the real-time video of the subject. The region specifying information is not limited to the information as long as the region specifying information is information configured to be able to notify the imaging device of a subject selected by the focus instruction device.

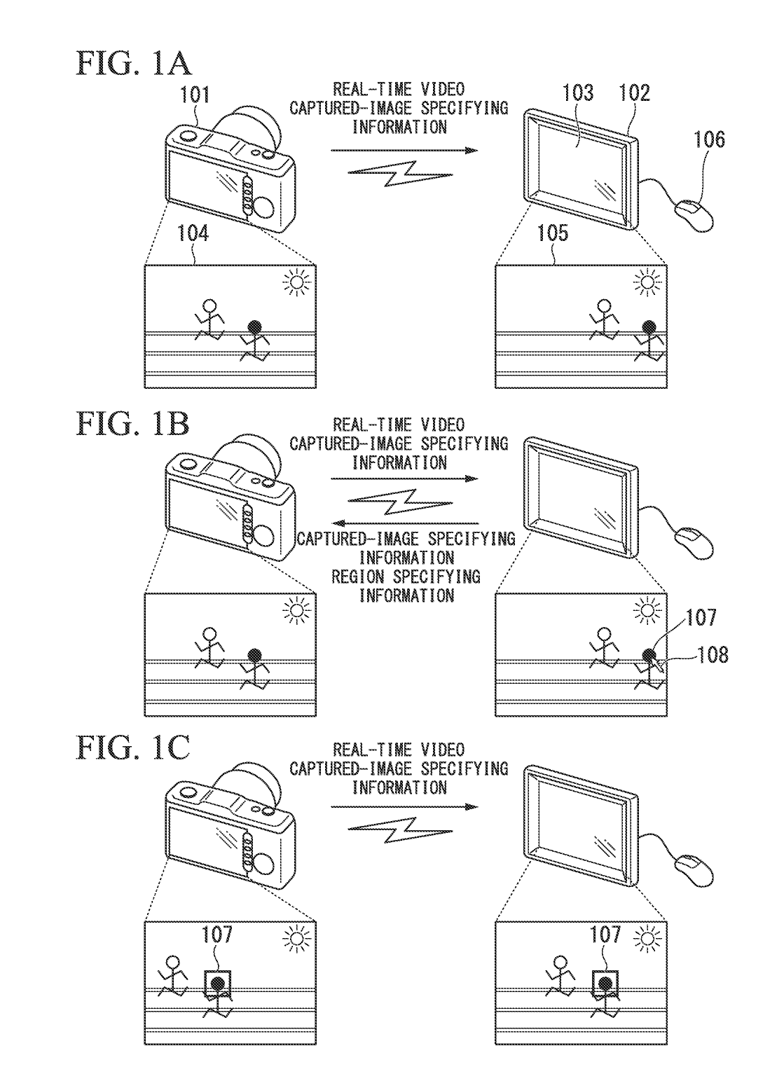

FIGS. 1A to 1C illustrate the configuration of the focus adjustment system according to the present embodiment. In the example illustrated in FIGS. 1A to 1C, an imaging device 101 is wirelessly connected to a focus instruction device 102 including a display unit 103. The imaging device 101 acquires a real-time video 104, stores the real-time video 104 in a storage device inside the imaging device 101, and wirelessly transmits the real-time video 104 and the captured-image specifying information to the focus instruction device 102. The focus instruction device 102 receives the real-time video 104 and the captured-image specifying information and displays the received real-time video 104 as a real-time video 105 in sequence on the display unit 103.

In this state, when a user gives a focus instruction using a user interface unit 106 included in the focus instruction device 102, the region specifying information and the captured-image specifying information associated with the real-time video 105 displayed by the focus instruction device 102 are transmitted to the imaging device 101. The imaging device 101 recognizes and focuses on a subject 107 selected by the user based on the received captured-image specifying information and region specifying information and the real-time video 104 and the captured-image specifying information stored in the imaging device 101.

According to the example illustrated in FIG. 1A, the imaging device 101 acquires the real-time video 104, stores the captured-image specifying information and the real-time video 104 in sequence in association therewith, and transmits the captured-image specifying information and the real-time video 104 to the focus instruction device 102. Also, in the example illustrated in FIG. 1A, the focus instruction device 102 receives the real-time video 104 and the captured-image specifying information and displays the real-time video 104 as the real-time video 105 in sequence on the display unit 103.

According to the example illustrated in FIG. 1B, the user gives a focus instruction by selecting the subject 107 present in the real-time video 105 with a cursor 108, using the user interface unit 106. Also, in the example illustrated in FIG. 1B, the focus instruction device 102 transmits the captured-image specifying information and the region specifying information to the imaging device 101 using an input of the focus instruction as a trigger.

According to the example illustrated in FIG. 1C, the imaging device 101 specifies and focuses on the subject 107 selected by the user based on the captured-image specifying information and the region specifying information received from the focus instruction device 102 and based on the real-time video 104 and the captured-image specifying information stored in the imaging device 101.

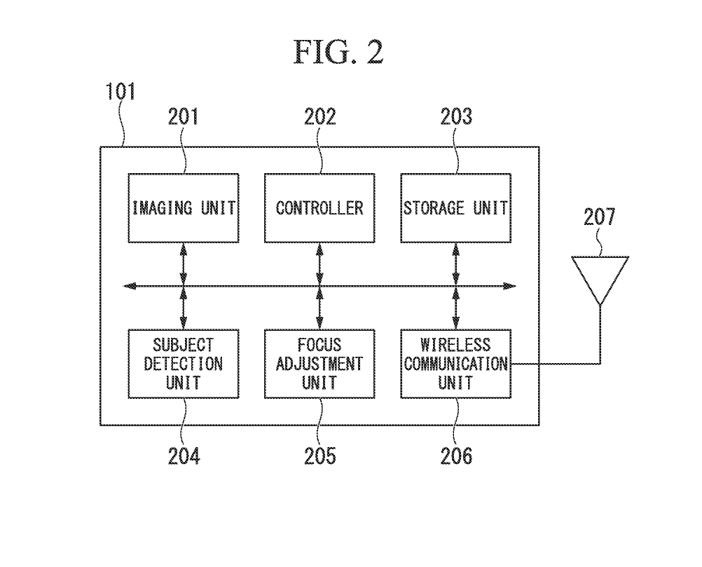

FIG. 2 is a diagram illustrating the configuration of the imaging device 101 according to the present embodiment. The configuration of the imaging device 101 will be described with reference to this drawing. The imaging device 101 includes an imaging unit 201, a controller 202, a storage unit 203, a subject detection unit 204, a focus adjustment unit 205, a wireless communication unit 206, and an antenna 207.

The imaging unit 201 repeats imaging and outputs captured images in sequence. The controller 202 controls an operation of the imaging device 101. The storage unit 203 stores at least the real-time video output from the imaging unit 201, the captured-image specifying information added in sequence to the captured images constituting the real-time video, the captured-image specifying information received from the focus instruction device 102, and the region specifying information.

The subject detection unit 204 detects a subject selected by the user from a captured image newly captured by the imaging unit 201. The subject detection unit 204 detects the subject based on the captured-image specifying information and the region specifying information received from the focus instruction device 102 and based on the real-time video 104 and the captured-image specifying information stored in the storage unit 203. The focus adjustment unit 205 performs focus adjustment to focus on the subject detected by the subject detection unit 204. The wireless communication unit 206 and the antenna 207 perform wireless communication with the focus instruction device 102. The wireless communication unit 206 and the antenna 207 wirelessly transmit the real-time video 104 and the captured-image specifying information in sequence to the focus instruction device 102 and wirelessly receive the captured-image specifying information and the region specifying information from the focus instruction device 102.

The storage unit 203 stores a program controlling an operation of the imaging device 101. The function of the imaging device 101 is realized, for example, by causing a CPU (not illustrated) of the imaging device 101 to read and execute the program controlling the operation of the imaging device 101.

The program controlling the operation of the imaging device 101 may be provided by a “computer-readable recording medium” such as, for example, a flash memory. Also, the above-described program may be input to the imaging device 101 by transmitting the program from a computer storing the program in a storage device or the like to the imaging device 101 via a transmission medium or by transmission waves in the transmission medium. The “transmission medium” used to transmit the program is a medium that has a function of transmitting information as in a network (communication network) such as the Internet or a communication link (communication line) such as a telephone line. Also, the above-described program may be a program realizing a part of the above-described function. Further, the above-described function may be a differential file (differential program) that can be realized in combination with a program recorded in advance on a computer.

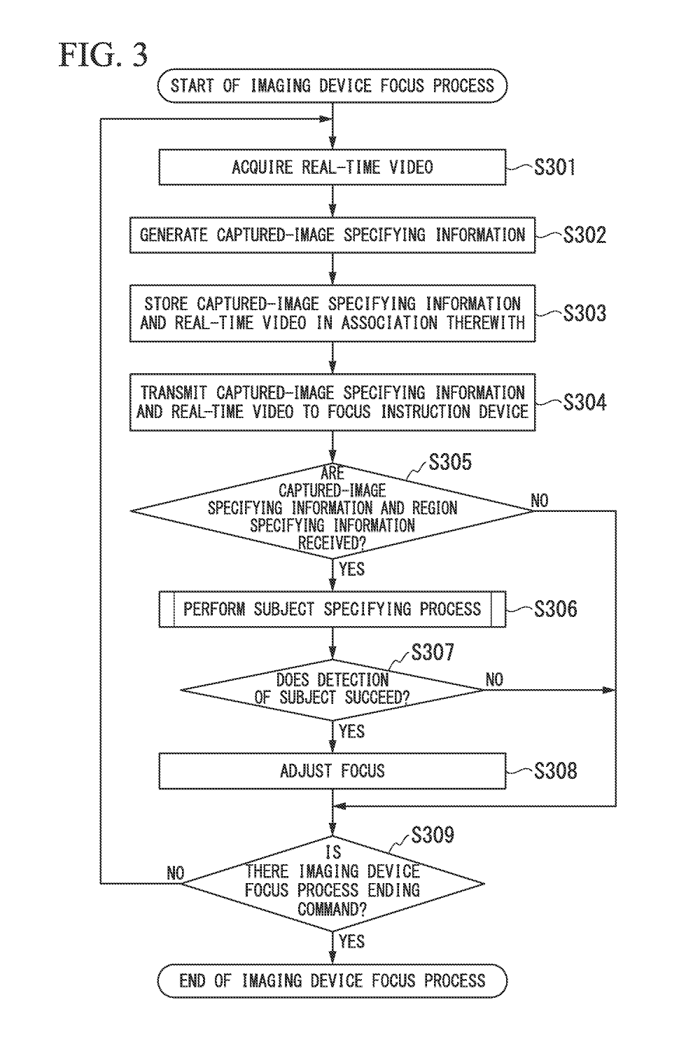

FIG. 3 illustrates the operation of the imaging device 101. The operation of the imaging device 101 will be described with reference to FIG. 3.

When the controller 202 receives an imaging device focus process starting command, which is a command to cause the imaging device 101 to start an imaging device focus process, the controller 202 starts the imaging device focus process and starts acquiring a real-time video by controlling the imaging unit 201 (step S301).

The imaging device focus process starting command according to the present embodiment is a command that is issued using the fact that the imaging device 101 establishes wireless connection with the focus instruction device 102 as a trigger. The imaging device focus process starting command according to the present embodiment may be a command that is issued, for example, using the fact that power is fed to the imaging device 101 or the user performs an input using the user interface unit added to the imaging device 101 as a trigger. The imaging device focus process starting command according to the present embodiment is not limited to the establishment of the wireless connection between the imaging device 101 and the focus instruction device 102 as the trigger.

When the real-time video is output from the imaging unit 201, the controller 202 generates the captured-image specifying information (step S302) and stores the real-time video and the captured-image specifying information in association therewith in the storage unit 203 (step S303). A method of storing the real-time video and the captured-image specifying information according to the present embodiment will be described below.

The controller 202 stores the real-time video and the captured-image specifying information in the storage unit 203, and subsequently transmits the real-time video and the captured-image specifying information to the focus instruction device 102 via the wireless communication unit 206 and the antenna 207 (step S304).

The controller 202 transmits the real-time video and the captured-image specifying information to the focus instruction device 102, and subsequently controls the wireless communication unit 206 and the antenna 207 such that the wireless communication unit 206 and the antenna 207 wait to receive the captured-image specifying information and the region specifying information transmitted from the focus instruction device 102. When the captured-image specifying information and the region specifying information are received within a predetermined period, the controller 202 stores the received captured-image specifying information and region specifying information in the storage unit 203, and subsequently causes the process to proceed to a subject specifying process shown in step S306. When the captured-image specifying information and the region specifying information are not received within the predetermined period, the controller 202 causes the process to proceed to a determination process of determining whether an imaging device focus process ending command shown in step S309 is issued (step S305).

The imaging device focus ending command according to the present embodiment is a command that is issued using the fact that the imaging device 101 disconnects the wireless connection with the focus instruction device 102 as a trigger. The imaging device focus ending command according to the present embodiment may be, for example, a command that is issued using the fact that the power of the imaging device 101 is cut off or the user performs an input using the user interface unit added to the imaging device 101 as a trigger. The imaging device focus ending command according to the present embodiment is not limited to the disconnection of the wireless connection between the imaging device 101 and the focus instruction device 102 as the trigger.

When the captured-image specifying information and the region specifying information are received from the focus instruction device 102 in step S305, the controller 202 issues a subject specifying process starting command to the subject detection unit 204. The controller 202 causes the focus instruction device 102 to start a subject specifying process of detecting a position at which a subject designated by the user is present in the real-time video acquired by the imaging device 101. When the subject detection unit 204 receives the subject specifying process starting command, the subject detection unit 204 performs the subject specifying process and issues a subject specifying process completion notification to the controller 202 (step S306).

The subject specifying process completion notification according to the present embodiment is a notification indicating that the subject specifying process is completed. The subject specifying process completion notification is a notification that includes at least one of subject detection information indicating whether detection of a subject succeeds and subject position information indicating a position at which the subject is present in the real-time video. The subject specifying process according to the present embodiment will be described below.

When the subject specifying process completion notification is received, the controller 202 determines whether the detection of the subject succeeds based on the subject detection information included in the subject specifying process completion notification. When the detection of the subject succeeds, the controller 202 causes the process to proceed to a focus adjustment process shown in step S308. When the detection of the subject fails, the controller 202 causes the process to proceed to a determination process of determining whether the imaging device focus process ending command shown in step S309 is issued (step S307).

When the controller 202 determines that the detection of the subject succeeds in step S307, the controller 202 controls the focus adjustment unit 205 such that the focus is adjusted at the position indicated by the subject position information included in the subject specifying process completion notification (step S308). Thus, the subject designated from the focus instruction device 102 can be focused on.

When the captured-image specifying information and the region specifying information is not received from the focus instruction device 102 within the predetermined period in step S305, or it is determined in step S307 that the detection of the subject fails, or the focus adjustment process of step S308 is completed, the controller 202 determines whether the imaging device focus process ending command is issued. When the imaging device focus process ending command is issued, the controller 202 ends the imaging device focus process. When the imaging device focus process ending command is not issued, the controller 202 performs the real-time video acquisition process shown in step S301 again (step S309).

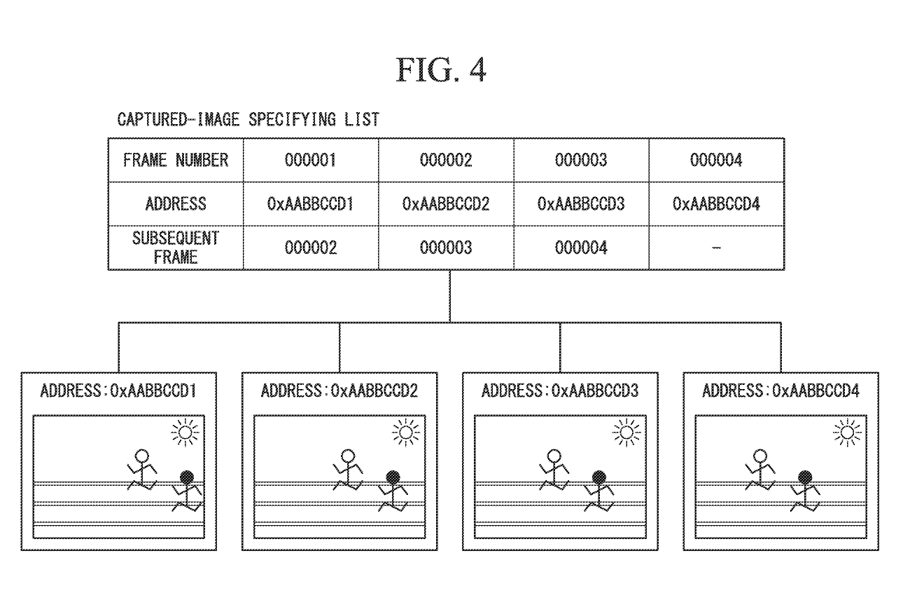

Next, a storing method when the real-time video and the captured-image specifying information shown in step S303 are stored in the storage unit 203 will be described with reference to FIG. 4. FIG. 4 illustrates an example of the method of storing the real-time video and the captured-image specifying information. The real-time video and the captured-image specifying information are stored in association therewith by a captured-image specifying list so that an address at which a captured image specified by the captured-image specifying information is stored can be acquired. The captured-image specifying list is stored in the storage unit 203 and is appropriately read for reference.

In FIG. 4, the captured-image specifying list is a list in which addresses, frame numbers, and frame numbers of subsequent frame periods are stored in association therewith. The addresses are the addresses at which the captured images of respective frame periods of the real-time video output from the imaging unit 201 in a sequential order are stored in the storage unit 203. The frame numbers are used which corresponds to the captured-image specifying information generated in step S302. When the captured images are stored in the storage unit 203 in step S303, the addresses at which the captured images are stored and the frame numbers corresponding to the captured-image specifying information generated in step S302 are stored in the captured-image specifying list. Also, the frame number is associated with the captured image stored in the storage unit 203 during the immediately previous frame period and is stored as the frame number of the subsequent frame period in the captured-image specifying list.

The address at which the captured image corresponding to this frame number is stored can be acquired based on the frame number stored in the captured-image specifying list. Also, with reference to the frame number of the subsequent frame period, the frame number can be retrieved in the order in which the imaging unit 201 captures the captured image.

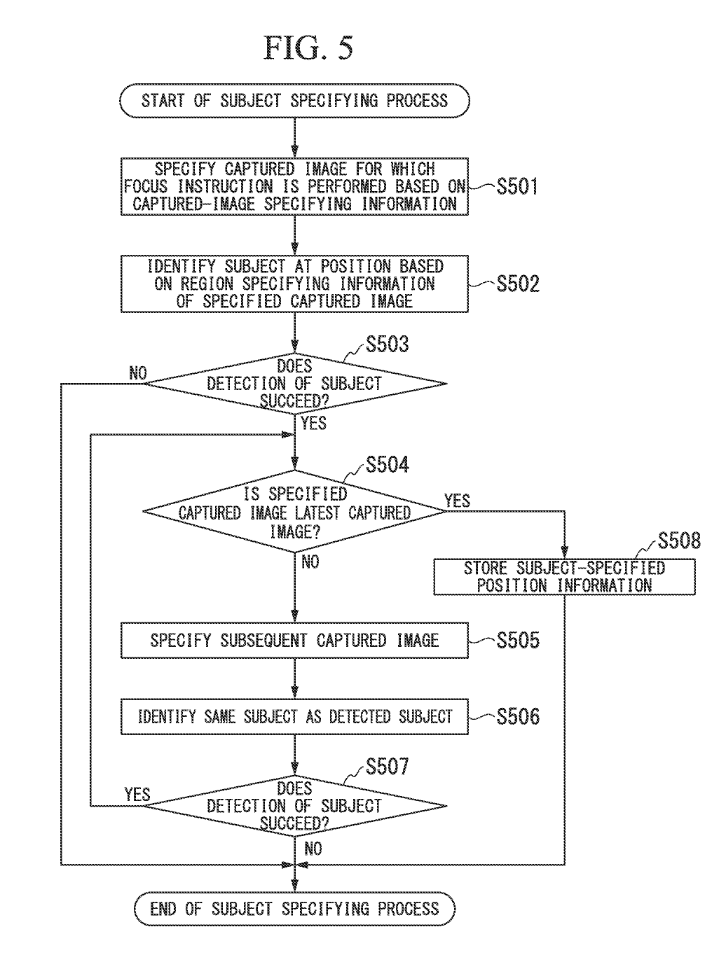

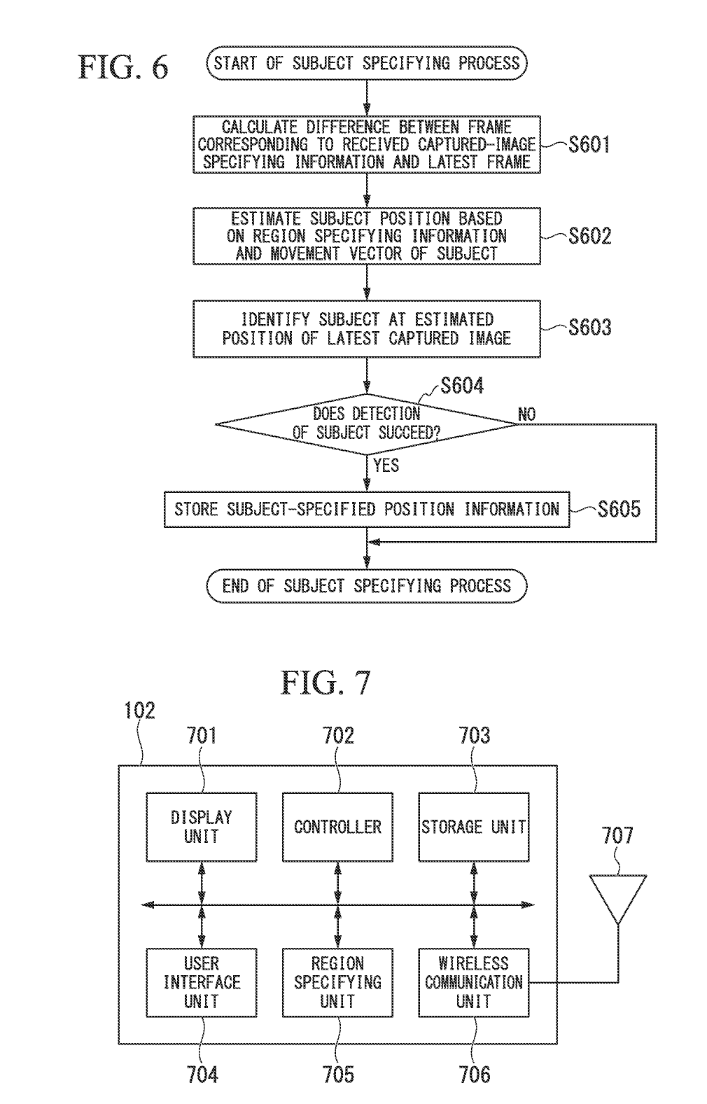

Next, details of the subject specifying process shown in step S306 will be described with reference to FIGS. 5 and 6. The subject specifying process is different in a processing method depending on whether the movement vector is used as a parameter of the subject specifying process. FIGS. 5 and 6 illustrate operations of the subject detection unit 204 corresponding to the respective methods.

FIG. 5 illustrates an operation of the subject detection unit 204 when the subject specifying process shown in step S306 is performed according to a processing method in which the movement vector is not used as the parameter of the subject specifying process. The subject detection unit 204 starts the subject specifying process when the subject specifying process starting command is received. When the subject specifying process starts, the subject detection unit 204 acquires the frame number stored in the storage unit 203 and corresponding to the captured-image specifying information received in step S305 from the focus instruction device 102. The subject detection unit 204 acquires the captured image (second captured image) of this frame number from the storage unit 203 (step S501).

The subject detection unit 204 acquires the captured image in step S501, subsequently specifies a position in the captured image, and detects a subject present in the specified position (step S502). The position in the captured image is specified by using the region specifying information stored in the storage unit 203 and received from the focus instruction device 102 in step S305.

When information included in the region specifying information is coordinates, the position in the captured image designated by the region specifying information is the coordinates. In this case, in step S502, the subject detection unit 204 detects a predetermined subject (for example, a face) from the position designated by the coordinates in the captured image. When the region specifying information is a face image of the subject, the position in the captured image designated by the region specifying information is a position at which a subject identical to the face image of the subject is present. In this case, in step S502, the subject detection unit 204 specifies the position of the subject by detecting the face image designated by the region specifying information in the captured image.

The subject detection unit 204 detects the subject in step S502 and subsequently determines whether the detection of the subject succeeds. When the detection of the subject succeeds, the subject detection unit 204 causes the process to proceed to a captured image determination process shown in step S504. When the detection of the subject fails, the subject detection unit 204 issues, to the controller 202, the subject specifying process completion notification including the subject detection information indicating that the specifying of the subject fails and ends the subject specifying process (step S503).

When it is determined that the detection of the subject succeeds in step S503, the subject detection unit 204 determines whether the captured image subjected to the detection of the subject is a latest captured image (first captured image) output from the imaging unit 201. The latest captured image output from the imaging unit 201 is an image (latest image) most recently captured by the imaging unit 201 at that time. When the captured image subjected to the detection of the subject is not the latest captured image output from the imaging unit 201, the subject detection unit 204 causes the process to proceed to a subsequent captured image specifying process shown in step S505. When the captured image subjected to the detection of the subject is the latest captured image output from the imaging unit 201, the subject detection unit 204 causes the process to proceed to a subject-specified position information storage process shown in step S508 (step S504).

In the present embodiment, whether the captured image subjected to the detection of the subject is the latest captured image output from the imaging unit 201 is determined, for example, by determining whether there is the frame number of the frame period subsequent to the frame period corresponding to the captured image subjected to the detection of the subject in the captured-image specifying list illustrated in FIG. 4. According to this determination process, it is determined that the captured image subjected to the detection of the subject is the latest captured image output from the imaging unit 201 when there is no frame number of the subsequent frame period. The method of determining whether the captured image subjected to the detection of the subject is the latest captured image output from the imaging unit 201 is not limited to the above-mentioned method of determining whether there is a frame number corresponding to the subsequent frame period. For example, the determination may be performed by storing the frame number of the latest captured image output from the imaging unit 201 in the storage unit 203 in advance, then comparing the frame number stored in the storage unit 203 and the frame number of the captured image subjected to the detection of the subject.

When the subject detection unit 204 determines that the captured image in which the subject is detected is not the latest captured image output from the imaging unit 201 in step S504, the subject detection unit 204 acquires a corresponding captured image (third captured image) from the storage unit 203 based on a frame number of a subsequent frame period included in the captured-image specifying list illustrated in FIG. 4 (step S505). In step S505, the captured image captured during the frame period subsequent to the frame period in which the captured image in which the subject is detected is captured is acquired.

The subject detection unit 204 acquires the captured image in step S505 and subsequently detects the same subject as the subject detected in steps S502 and S503 in the captured image acquired in step S505 (step S506). For example, when the subject is a face, the subject detection unit 204 detects the same face as the face detected in steps S502 and S503 from the captured image acquired in step S505 by pattern matching.

The subject detection unit 204 detects the subject in step S506 and subsequently determines whether the detection of the subject succeeds. When the detection of the subject succeeds, the subject detection unit 204 performs the captured image determination process shown in step S504 again. When the detection of the subject fails, the subject detection unit 204 issues, to the controller 202, a subject specifying process completion notification including subject detection information indicating that the specifying of the subject fails and ends the subject specifying process (step S507).

When the subject detection unit 204 determines that the captured image in which the subject is detected is the latest captured image output from the imaging unit 201 in step S504, the subject detection unit 204 stores, in the storage unit 203, position information regarding a position at which the detected subject is present in the captured image. The subject detection unit 204 issues, to the controller 202, the subject specifying process completion notification including two pieces of information, i.e., the subject detection information indicating that the detection of the subject succeeds and the subject position information indicating the information regarding the position of the subject in the captured image finally output from the imaging unit 201, and ends the subject specifying process (step S507).

FIG. 6 illustrates an operation of the subject detection unit 204 when the subject specifying process shown in step S306 is performed by a processing method in which the movement vector is used as the parameter of the subject specifying process. The movement vector includes information regarding a movement amount of the subject. The subject detection unit 204 starts the subject specifying process when the subject specifying process starting command is received. When the subject specifying process starts, the subject detection unit 204 calculates a frame difference amount which is a difference amount between the frame period corresponding to the latest captured image output from the imaging unit 201 and the frame period corresponding to the captured image specified by the captured-image specifying information. The captured-image specifying information is received in step S305 from the focus instruction device 102 and stored in the storage unit 203. The subject detection unit 204 stores a calculation result of the frame difference amount in the storage unit 203 (step S601).

The frame difference amount according to the present embodiment is a number of frame periods between the frame period corresponding to the captured image specified by the captured-image specifying information received in step S305 from the focus instruction device 102 and the frame period corresponding to the latest captured image output from the imaging unit 201. In other words, the frame difference amount is the number of captured images captured during a period from a moment at which the captured image specified by the captured-image specifying information received from the focus instruction device 102 in step S305 is captured to a moment at which the latest captured image output from the imaging unit 201 is captured.

The frame difference amount is calculated by tracing the captured images from the captured image corresponding to the frame number specified by the captured-image specifying information received in step S305 from the focus instruction device 102 to the latest captured image output from the imaging unit 201 in the captured-image specifying list illustrated in FIG. 4 in an order of the frame numbers and counting the number of the captured images. The calculation of the frame difference amount is not limited to the calculation performed by tracing the captured images in order. Another method may be used as the method of calculating the frame difference amount. For example, the frame difference amount may be calculated by storing the frame number of the latest captured image output from the imaging unit 201 in the storage unit 203 in advance, and calculating a difference between the frame number of the latest captured image output from the imaging unit 201 and the frame number of the captured image subjected to the detection of the subject.

The subject detection unit 204 calculates the frame difference amount in step S601 and subsequently specifies a position in the captured image. The specified position corresponds to the position designated by the region specifying information received in step S305 from the focus instruction device 102 in the captured image. The captured image is specified by the captured-image specifying information received in step S305 from the focus instruction device 102. Also, the subject detection unit 204 estimates a position at which the subject is present in the latest captured image output from the imaging unit 201 by compensating the specified position based on the movement vector of the subject and the frame difference amount (step S602).

When coordinates is included in the region specifying information, the position in the captured image designated by the region specifying information is the position indicated by the coordinates. Also, when a face image of the subject is included in the region specifying information, the position in the captured image designated by the region specifying information is a position at which a subject identical to the face image of the subject is present. In this case, the subject detection unit 204 acquires, from the storage unit 203, the captured image specified by the captured-image specifying information received in step S305 from the focus instruction device 102. The subject detection unit 204 detects a face image designated by the region specifying information in the acquired captured image and specifies the position of the subject.

Also, the estimation of the position at which the subject is present in the latest captured image output from the imaging unit 201 is performed using equation (1). In equation (1), P, P′, V, and N are an estimation result of the position at which the subject is present, the position designated by the region specifying information, the movement vector during one frame period, and the frame difference amount calculated in step S601, respectively.

P(X,Y)=P′(X,Y)+V(Vx,Vy)×N (1)

The subject detection unit 204 estimates the position of the subject in step S602 and subsequently detects the subject present at the position estimated in step S602 in the latest captured image output from the imaging unit 201 (step S603). For example, in step S603, the subject detection unit 204 detects a predetermined subject (for example, a face) from the position estimated in step S602 in the latest captured image output from the imaging unit 201. When the face image of the subject is included in the region specifying information, the subject detection unit 204 detects the subject from the latest captured image output from the imaging unit 201 in step S603 and subsequently confirms whether the detected subject is identical to the face image of the subject included in the region information.

The subject detection unit 204 detects the subject in step S603 and subsequently determines whether the detection of the subject succeeds. When the detection of the subject succeeds, the subject detection unit 204 causes the process to proceed to a subject-specified position information storage process shown in step S605. When the detection of the subject fails, the subject detection unit 204 issues, to the controller 202, a subject specifying process completion notification including subject detection information indicating that the detection of the subject fails and ends the subject specifying process (step S604).

When the subject detection unit 204 determines that the detection of the subject succeeds in step S604, the subject detection unit 204 stores the information regarding the position of the subject estimated in step S602 in the storage unit 203. In this case, the subject detection unit 204 issues, to the controller 202, the subject specifying process completion notification including two pieces of information, i.e., a subject detection information indicating that the detection of the subject succeeds and a subject position information indicating the position of the subject in the captured image finally output from the imaging unit 201, and ends the subject specifying process (step S605).

The imaging device 101 according to the first embodiment corresponds to an imaging device of the most superordinate concept according to the present invention. For example, the imaging device according to the present invention can be realized by configuring the imaging unit 201 as an imaging unit of the imaging device according to the present invention, configuring the wireless communication unit 206 as a wireless communication unit of the imaging device according to the present invention, configuring the subject detection unit 204 as a subject detection unit of the imaging device according to the present invention, and configuring the focus adjustment unit 205 as a focus adjustment unit of the imaging device according to the present invention. Configurations not mentioned above are not essential configurations of the imaging device according to the present invention.

According to the present embodiment, the subject present at the position or the region indicated by the region specifying information received from the focus instruction device 102 in the captured image specified by the captured-image specifying information received from the focus instruction device 102 is detected from the latest captured image output from the imaging unit 201. By adjusting the focus so that the detected subject is in focus, the subject designated by the focus instruction device 102 can be focused on with higher precision. In particular, even in a system in which a time lag between acquisition of a real-time video by the imaging unit and display of the real-time video by the display unit is large, the designated subject can be focused on with higher precision.

As shown in steps S501 and S502 of FIG. 5, the subject is detected in the captured image specified by the captured-image specifying information. Thereafter, as shown in steps S505 and S506 of FIG. 5, the subject can be tracked with higher precision by detecting the subject while changing the captured image of a subject detection target until the subject is detected on the latest captured image. As a result, the subject designated by the focus instruction device 102 can be focused on with higher precision.

Also, as shown in step S602 of FIG. 6, the position of the subject is tracked by the movement vector of the subject received from the focus instruction device 102. Thereafter, as shown in step S603 of FIG. 6, the subject having a constant motion can be tracked with higher precision by detecting the subject present at the estimated position in the latest captured image. As a result, the subject designated by the focus instruction device 102 can be focused on with higher precision.

### Second Embodiment

Next, a second embodiment of the present invention will be described. The present embodiment is characterized in an operation of a focus instruction device 102 and a method of designating a subject. The operation of the imaging device 101 according to the present embodiment is the same as the operation described in the first embodiment.

FIG. 7 illustrates the configuration of the focus instruction device 102 according to the present embodiment. The configuration of the focus instruction device 102 will be described with reference to this drawing. The focus instruction device 102 includes a display unit 701 (corresponding to the display unit 103 in FIG. 1), a controller 702, a storage unit 703, a user interface unit 704 (corresponding to the user interface unit 106 in FIG. 1), a region specifying unit 705, a wireless communication unit 706, and an antenna 707.

The display unit 701 displays a real-time video received from the imaging device 101 via the wireless communication unit 706 and the antenna 707. The controller 702 controls an operation of the focus instruction device 102. The storage unit 703 stores the real-time video and captured-image specifying information received from the imaging device 101 via the wireless communication unit 706 and the antenna 707 and stores the region specifying information to be transmitted to the imaging device 101. The user interface unit 704 receives an input by a user. The region specifying unit 705 generates the region specifying information. The wireless communication unit 706 and the antenna 707 perform wireless communication with the imaging device 101, wirelessly receive a real-time video 104 and the captured-image specifying information in sequence from the imaging device 101, and wirelessly transmit the captured-image specifying information and the region specifying information to the imaging device 101.

The storage unit 703 stores a program controlling an operation of the focus instruction device 102. The function of the focus instruction device 102 is realized, for example, by causing a CPU (not illustrated) of the focus instruction device 102 to read and execute the program controlling the operation of the focus instruction device 102. The program controlling the operation of the focus instruction device 102 may be provided by a “computer-readable recording medium” as in, for example, a flash memory. Also, the above-described program may be input to the focus instruction device 102 by transmitting the program from a computer storing the program in a storage device or the like to the focus instruction device 102 via a transmission medium or by transmission waves in the transmission medium.

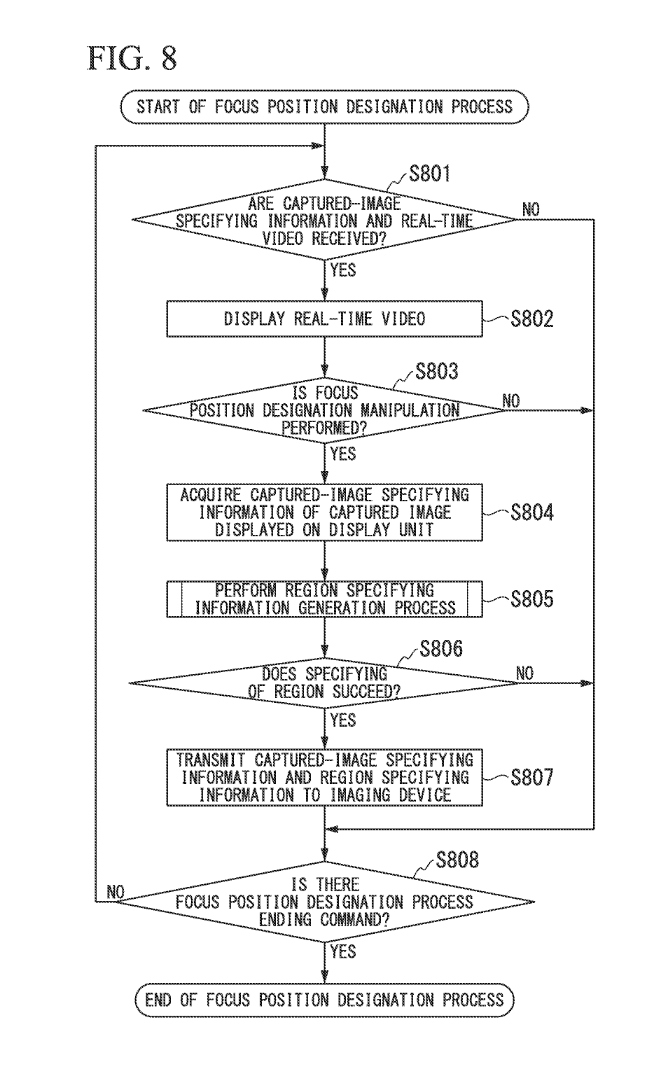

FIG. 8 illustrates the operation of the focus instruction device 102. The operation of the focus instruction device 102 will be described with reference to FIG. 8. When the controller 702 receives a focus position designation process starting command, which is a command to cause the focus instruction device 102 to start a focus position designation process, the controller 702 starts the focus position designation process. When the focus position designation process starts, the controller 702 controls the wireless communication unit 706 and the antenna 707 such that the wireless communication unit 706 and the antenna 707 wait to receive the captured-image specifying information and the real-time video. When the captured-image specifying information and the real-time video are received within a predetermined period, the controller 702 causes the process to proceed to a real-time video display process shown in step S802. When the captured-image specifying information and the real-time video are not received within a predetermined period, the controller 702 causes the process to proceed to a process of determining whether a focus position designation process ending command is issued, as will be shown in step S808 (step S801).

The focus position designation process starting command according to the present embodiment is a command that is issued using the fact that the focus instruction device 102 establishes wireless connection with the imaging device 101 as a trigger. The focus position designation process starting command according to the present embodiment is not limited to the establishment of the wireless connection with the imaging device 101 as the trigger. The focus position designation process starting command according to the present embodiment may be a command that is issued, for example, using feeding of power to the focus instruction device 102 or an input from the user interface unit 704 as a trigger.

The focus position designation process ending command according to the present embodiment is a command that is issued using the fact that the focus instruction device 102 disconnects the wireless connection with the imaging device 101 as a trigger. The focus position designation process ending command according to the present embodiment is not limited to the disconnection of the wireless connection from the imaging device 101 as the trigger. The focus position designation process ending command according to the present embodiment may be, for example, a command that is issued using cutoff of the power of the focus instruction device 102 or an input from the user interface unit 704 as a trigger.

When the captured-image specifying information and the real-time video are received via the wireless communication unit 706 and the antenna 707 in step S801, the controller 702 stores the received captured-image specifying information and real-time video in the storage unit 703 and subsequently controls the display unit 701 such that the received real-time video is displayed (step S802).

The controller 702 displays the real-time video on the display unit 701 in step S802 and subsequently determines whether the user has executed a focus position designation manipulation using the user interface unit 704. When the focus position designation manipulation has been executed, the controller 702 causes the process to proceed to a captured-image specifying information acquisition process shown in step S804. When the focus position designation manipulation has not been executed, the controller 702 causes the process to proceed to a process of determining whether the focus position designation process ending command is issued, as will be shown in step S808 (step S803).

The focus position designation manipulation according to the present embodiment is executed as that the user manipulates a mouse corresponding to the user interface unit 704 to select a desired subject, but any configuration by which the user can select a desired subject may be carried out. The focus position designation manipulation according to the present embodiment is not limited to an input by manipulation of a mouse.

When it is determined in step S803 that the focus position designation manipulation is executed, the controller 702 acquires the captured-image specifying information simultaneously received with the captured image being displayed on the display unit 701 at the time of execution of the focus position designation manipulation as the captured-image specifying information to be transmitted to the imaging device 101. Subsequently, the controller 702 stores the captured-image specifying information in the storage unit 703 (step S804). Thus, the captured image at the time of the execution of the focus position designation manipulation is specified and the captured-image specifying information of the captured image is stored in the storage unit 703.

The controller 702 acquires the captured-image specifying information in step S804 and performs the storage process, and subsequently issues a region specifying information generation process starting command to the region specifying unit 705 to start a region specifying information generation process. When a region specifying information generation process starting command is received, the region specifying unit 705 starts the region specifying information generation process and issues a region specifying information generation process completion notification to the controller 702 (step S805).

The region specifying information generation process completion notification according to the present embodiment is a notification indicating that the region specifying information generation process is completed. The region specifying information generation process completion notification according to the present embodiment is information that includes at least one of a region specifying result indicating whether the specifying of a region subjected to the focus position designation manipulation succeeds and coordinates information subjected to the focus position designation manipulation. The region specifying information generation process according to the present embodiment will be described below.

When the region specifying information generation process completion notification is received, the controller 702 determines whether the specification of the region succeeds based on the region specifying result information included in the region specifying information generation process completion notification. When the specification of the region succeeds, the controller 702 causes the process to proceed to a process of transmitting the captured-image specifying information and the region specifying information, as shown in step S807. When the specification of the region fails, the controller 702 moves a determination process of determining whether the focus position designation process ending command is issued, as will be shown in step S808 (step S806).

When the controller 702 determines that the specification of the region succeeds in step S806, the controller 702 transmits the captured-image specifying information acquired and stored in step S804 to the imaging device 101 and transmits the coordinates information acquired in step S805 as the region specifying information to the imaging device 101 (step S807).

When the captured-image specifying information and the real-time video are not received within the predetermined period in step S801, or the focus position designation manipulation is not executed in step S803, or the specification of the region fails in step S806, the controller 702 transmits the captured-image specifying information and the region specifying information to the imaging device 101 in step S807 and subsequently determines whether the focus position designation process ending command is issued. When the focus position designation process ending command is issued, the controller 702 ends the focus position designation process. When the focus position designation process ending command is not issued, the controller 702 performs the process of waiting to receive the captured-image specifying information and the real-time video again, as shown in step S801.

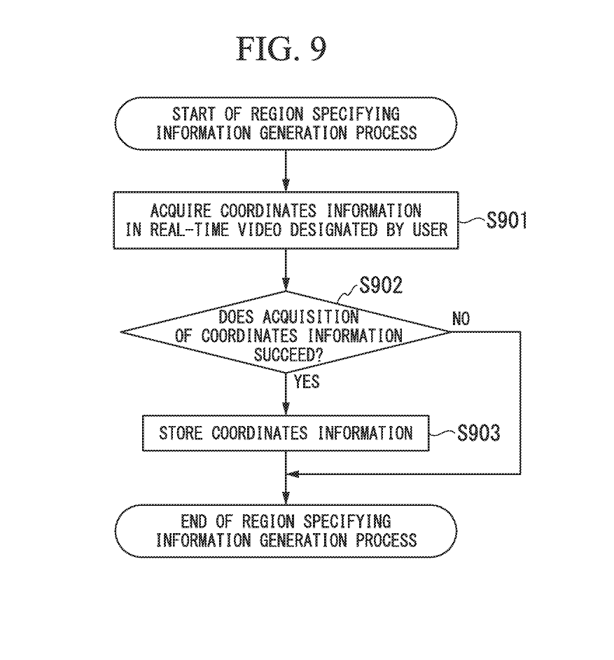

Next, details of the region specifying information generation process shown in step S805 will be described with reference to FIG. 9. The region specifying unit 705 starts the region specifying information generation process when the region specifying information generation process starting command is received. When the region specifying information generation process starts, the region specifying unit 705 acquires the coordinates information in the real-time video designated by the user (step S901).

The region specifying unit 705 acquires the coordinates information in step S901 and subsequently determines whether the acquisition of the coordinates information succeeds. When the acquisition of the coordinates information succeeds, the region specifying unit 705 causes the process to proceed to a coordinates information storage process shown in step S903. When the acquisition of the coordinates information fails, the region specifying unit 705 issues, to the controller 202, the region specifying information generation process completion notification including the region specifying result information that indicates that the specification of the region fails and ends the region specifying information generation process (step S902).

When the position of the cursor 108 illustrated in FIG. 1B is present in the captured image, the coordinates information according to the present embodiment is acquired as the coordinates of the position of the cursor 108. When the position of the cursor 108 is not present in the captured image, the specification of the region fails.

When it is determined in step S902 that the acquisition of the coordinates information succeeds, the region specifying unit 705 stores the acquired coordinates information in the storage unit 703. Also, the region specifying unit 705 issues, to the controller 202, the region specifying information generation process completion notification including the region specifying result information indicating that the specification of the region succeeds and the coordinates information acquired in step S901 and ends the region specifying information generation process (step S903).

The focus instruction device 102 according to the second embodiment corresponds to a focus instruction device of the most superordinate concept according to the present invention. For example, the focus instruction device according to the present invention can be realized by configuring the wireless communication unit 206 as a wireless communication unit of the focus instruction device according to the present invention and configuring the controller 702 and the region specifying unit 705 as a specifying unit of the focus instruction device according to the present invention. Configurations not mentioned above are not essential configurations of the focus instruction device according to the present invention.

According to the present embodiment, as described above, since the focus instruction device 102 transmits the captured-image specifying information and the region specifying information regarding the captured image in which the subject is designated to the imaging device 101, the focus instruction device 102 can notify the imaging device 101 of the information regarding the captured image used to designate the subject and the position or the region at which the subject is present.

As described in the first embodiment, the imaging device 101 detects the subject present at the position or the region indicated by the region specifying information received from the focus instruction device 102 in the captured image specified by the captured-image specifying information received from the focus instruction device 102, from the captured image finally output from the imaging unit 201. The imaging device 101 adjusts the focus so that the detected subject is in focus. Thus, it is possible to focus on the subject designated by the focus instruction device 102 with higher precision. In particular, even in a system in which a time lag between acquisition of a real-time video by the imaging unit and display of the real-time video by the display unit is large, the designated subject can be focused on with higher precision.

In the present embodiment, the user has designated the subject using the user interface unit 704, but the subject may be automatically designated. For example, when a face image of a subject on which focus is desired is stored in the storage unit 703 and a focus instruction is given by manipulating the user interface unit 704, the region specifying unit 705 may detect the same subject as the face image from a captured image.

### Modified Examples

Next, modified examples of the above-described embodiments will be described.

### Modified Example 1

In the subject specifying process illustrated in FIG. 5 according to the first and second embodiments of the present invention, the same subject as the subject detected in step S502 is detected in sequence in the captured images of all of the frame periods from the captured image specified by the captured-image specifying information to the latest captured image captured by the imaging device 101. Thus, the position at which the subject is present in the latest captured image captured by the imaging device 101 is specified. Further, for example, the same subject as the subject detected in step S502 may be detected in the captured image for each predetermined number of frame periods.

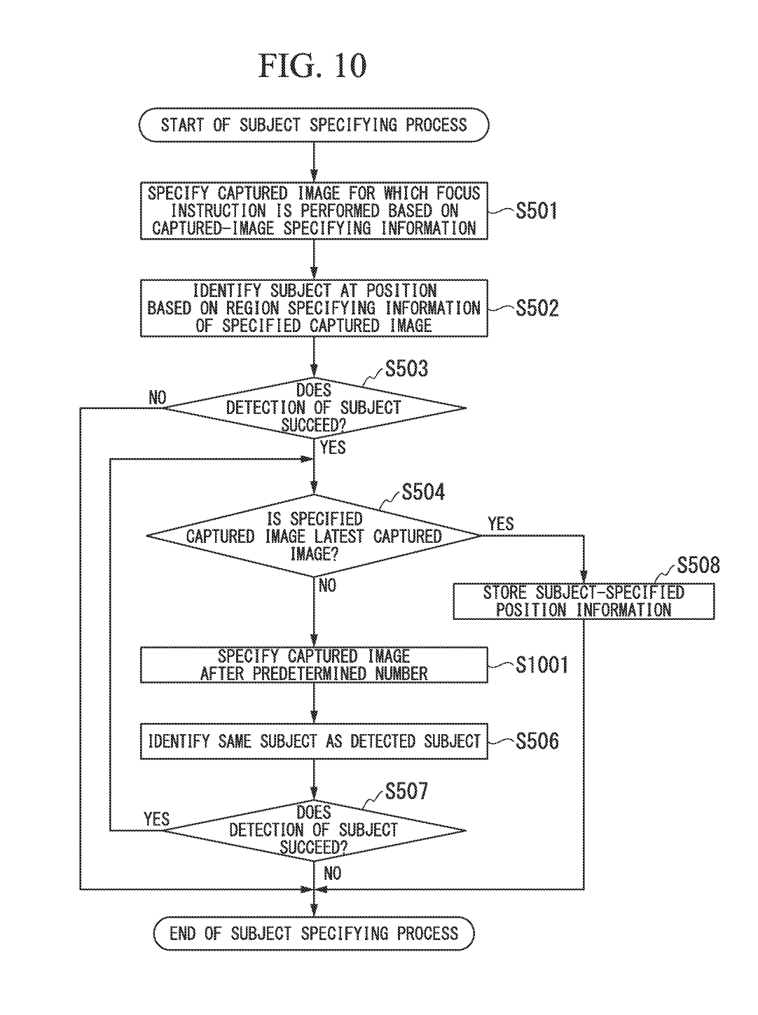

FIG. 10 illustrates a subject specifying process according to a modified example 1. When the subject in the latest captured image captured by the imaging device 101 is detected for each predetermined number of frame periods, the subsequent captured image specifying process shown in step S505 of FIG. 5 changes to a process of specifying the captured image after the predetermined number of frame periods, as shown in step S1001 of FIG. 10. In step S1001, the subject detection unit 204 acquires the captured image from the storage unit 203. The captured image corresponds to a frame number obtained by increasing the frame number by a predetermined number of the specified captured image. The specified captured image is specified based on the frame number included in the captured-image specifying list illustrated in FIG. 4.

In the subject specifying process shown in the modified example 1, some captured images are skipped when proceeding among all of the captured images captured in a sequential order from the captured image specified by the captured-image specifying information received from the focus instruction device 102 to the latest captured image captured by the imaging device 101. In the subject specifying process shown in the modified example 1, the subject is detected in the captured images excluding the skipped captured images. Thus, since the number of the repetition processes of specifying the subject is decreased, the subject specifying process can be performed at a higher speed.

### Modified Example 2

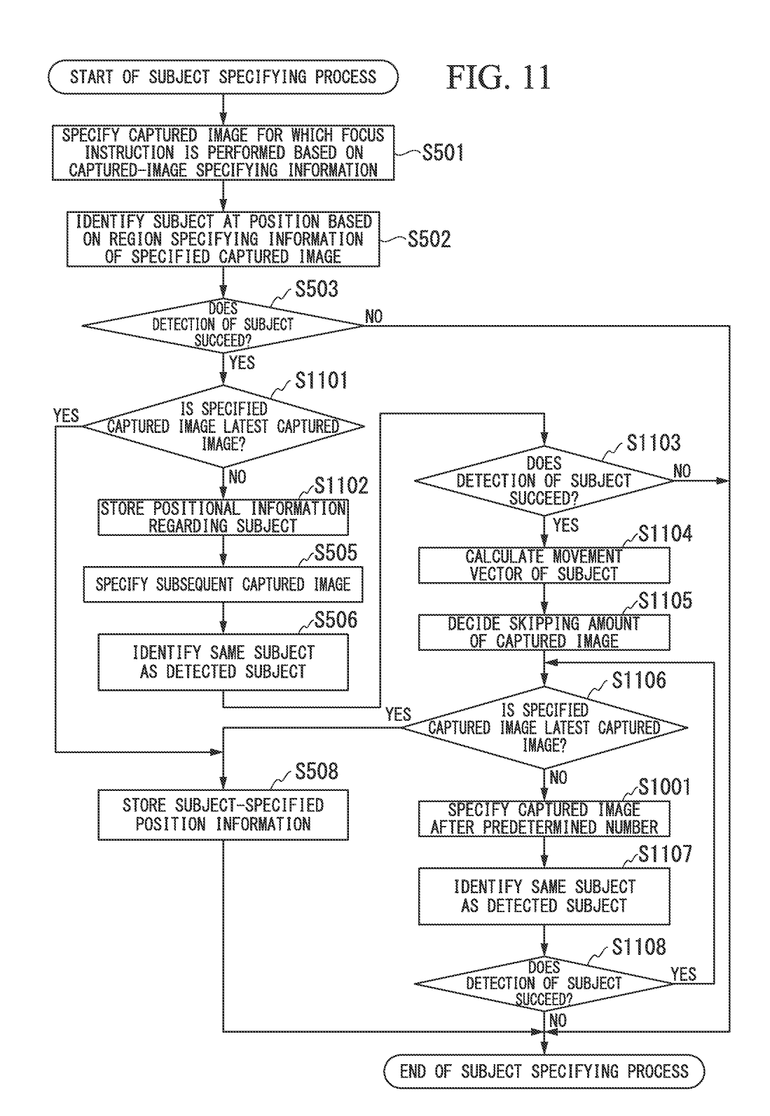

FIG. 11 illustrates a subject specifying process according to a modified example 2. For example, the predetermined number of frames in the modified example 1 may be decided based on the movement vector of the subject. A subject specifying process according to the modified example 2 will be described with reference to FIG. 11.

In FIG. 11, as in the subject specifying process illustrated in FIG. 5, in step S502, a subject is detected in the captured image specified by the captured-image specifying information received from the focus instruction device 102. When the subject detection unit 204 determines that the detection of the subject succeeds in step S503, the subject detection unit 204 determines whether the captured image subjected to the detection of the subject is the latest captured image output from the imaging unit 201. When the captured image subjected to the detection of the subject is the latest captured image output from the imaging unit 201, the subject detection unit 204 causes the process to proceed to a subject-specified position information storage process shown in step S508. When the captured image subjected to the detection of the subject is not the latest captured image output from the imaging unit 201, the subject detection unit 204 causes the process to proceed to a process of storing the information regarding the position of the subject, as shown in step S1102 (step S1101).

When the subject detection unit 204 determines that the captured image subjected to the detection of the subject is not the latest captured image output from the imaging unit 201 in step S1101, the position information of the subject detected in the captured image specified by the captured-image specifying information is stored in the storage unit 203 (step S1102). The subject detection unit 204 specifies the subsequent captured image in step S505 and subsequently detects the same subject as the subject detected in steps S502 and S503 in the captured image specified in step S505 (step S506).

The subject detection unit 204 detects the subject in step S506 and subsequently determines whether the detection of the subject succeeds (step S1103). When the detection of the subject succeeds, the subject detection unit 204 calculates the movement vector of the subject by calculating a difference between the positions based on the information regarding the position of the detected subject and the position information stored in the storage unit 203 in step S1102 (step S1104). When the detection of the subject fails, the subject detection unit 204 issues, to the controller 202, a subject specifying process completion notification including subject detection information indicating that the specifying of the subject fails, as in the subject specifying process illustrated in FIG. 5, and ends the subject specifying process.

The movement vector of the subject is calculated in step S1104 using an equation (2). In the equation (2), V indicates the movement vector of the subject, Pn indicates the information regarding the position of the subject specified in step S1103, and Pn−1 indicates the information regarding the position of the subject stored in the storage unit 203 in step S1102.

V(Vx,Vy)=(Pn(Xn,Yn)−Pn−1(Xn−1,Yn−1) (2)

The subject detection unit 204 calculates the movement vector of the subject in step S1104 and subsequently decides a skipping amount of the captured image according to a magnitude of the movement vector (step S1105). The skipping amount of the captured image is a number of the captured images skipped when the subsequent captured image is specified from the specified captured image to the latest captured image. For example, the larger the movement vector is, the smaller the skipping amount of the captured image is. The smaller the movement vector is, the larger the skipping amount of the captured image is.

The subject detection unit 204 decides the skipping amount of the captured image in step S1105 and subsequently determines whether the captured image subjected to the detection of the subject is the latest captured image output from the imaging unit 201 (step S1106). When the captured image subjected to the detection of the subject is not the latest captured image output from the imaging unit 201, the subject detection unit 204 performs a captured-image specifying process shown in step S1001 after a predetermined number of frame periods according to the skipping amount of the captured image decided in step S1105. When the captured image subjected to the detection of the subject is the latest captured image output from the imaging unit 201, the subject detection unit 204 causes the process to proceed to a subject-specified position information storage process shown in step S508.

When the subject detection unit 204 determines that the captured image subjected to the detection of the subject is not the latest captured image output from the imaging unit 201 in step S1106, the subject detection unit 204 specifies the captured image in step S1001 and subsequently detects the same subject as the latest detected subject in the captured image acquired in step S1001 (step S1107). For example, when the subject is a face, the subject detection unit 204 detects the same face as the latest detected face from the captured image acquired in step S1001 using pattern matching.

The subject detection unit 204 detects the subject in step S1107 and subsequently determines whether the detection of the subject succeeds. When the detection of the subject succeeds, the subject detection unit 204 again performs the process of determining whether the specified captured image is the latest captured image output from the imaging unit 201, as shown in step S1106. When the detection of the subject fails, the subject detection unit 204 issues, to the controller 202, a subject specifying process completion notification including subject detection information indicating that the specifying of the subject fails and ends the subject specifying process, as in the subject specifying process illustrated in FIG. 5.

In the subject specifying process shown in the modified example 2, the movement vector of the subject between the captured images in which the subject is detected, is calculated. In the subject specifying process shown in the modified example 2, the number of captured images skipped when proceeding from the captured image in which the subject is already detected to the captured image in which the subject is subsequently detected is decided based on the calculated movement vector. Thus, it is possible to optimize balance between the subject tracking precision and the reduction in the load of the subject specifying process according to the magnitude of the movement vector.

### Modified Example 3

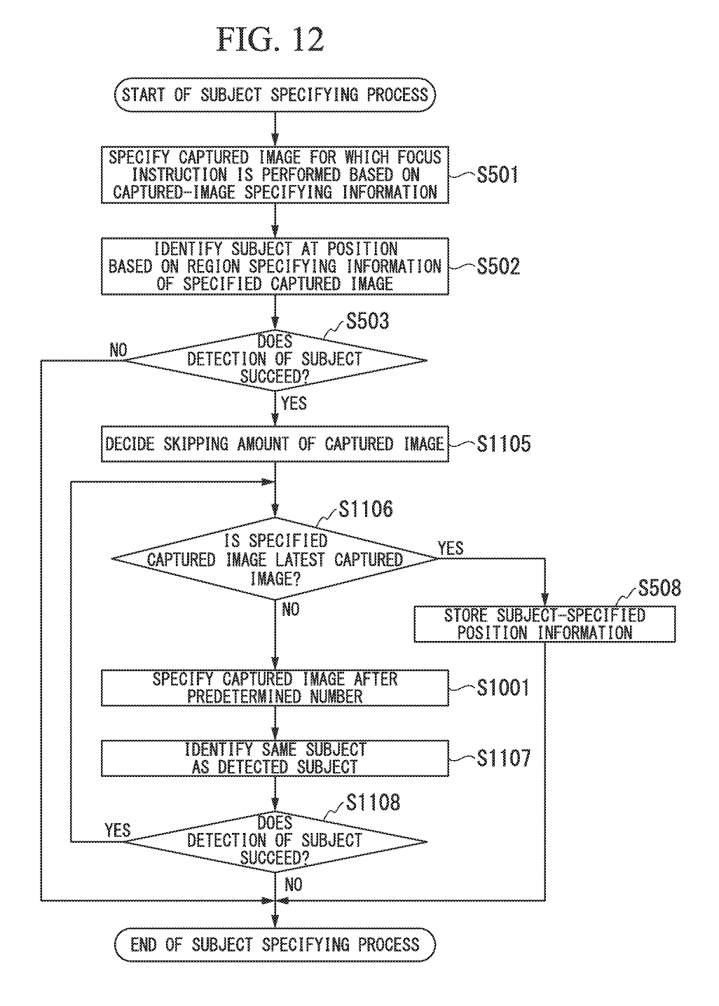

FIG. 12 illustrates a subject specifying process according to a modified example 3. According to the modified example 3, the predetermined number in the modified example 2 may be decided, for example, based on the movement vector of the subject received from the focus instruction device 102. A subject specifying process according to the modified example 3 will be described with reference to FIG. 12.

In the modified example 3, the processes of steps S1101 to S1104 in the modified example 2 are not performed. When the subject detection unit 204 determines that the detection of the subject succeeds in step S503, the subject detection unit 204 calculates a skipping amount of the captured image based on the movement vector of the subject included in the region specifying information received from the focus instruction device 102 (step S1105).

Since the movement vector is not calculated in the subject specifying process shown in the modified example 3, it is possible to reduce the load of the subject specifying process.

### Modified Example 4

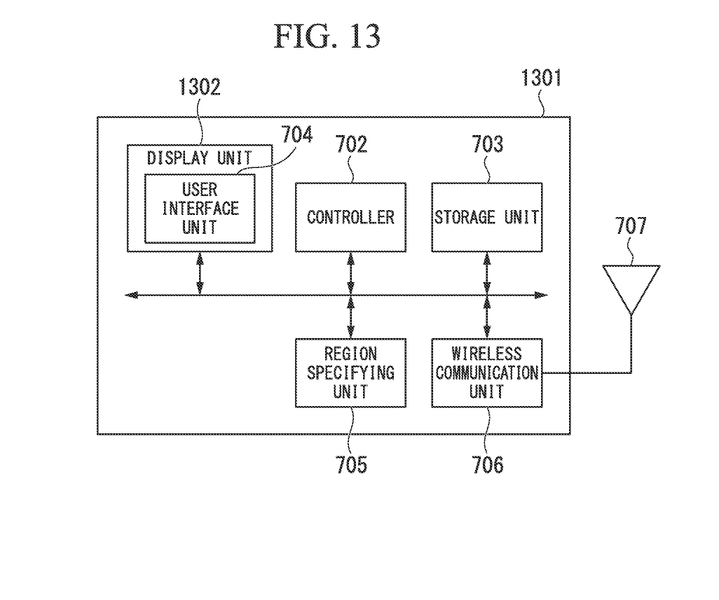

For example, in the second embodiment of the present invention, as illustrated in FIG. 13, a display unit 1302 of a focus instruction device 1301 may include a user interface unit 704.

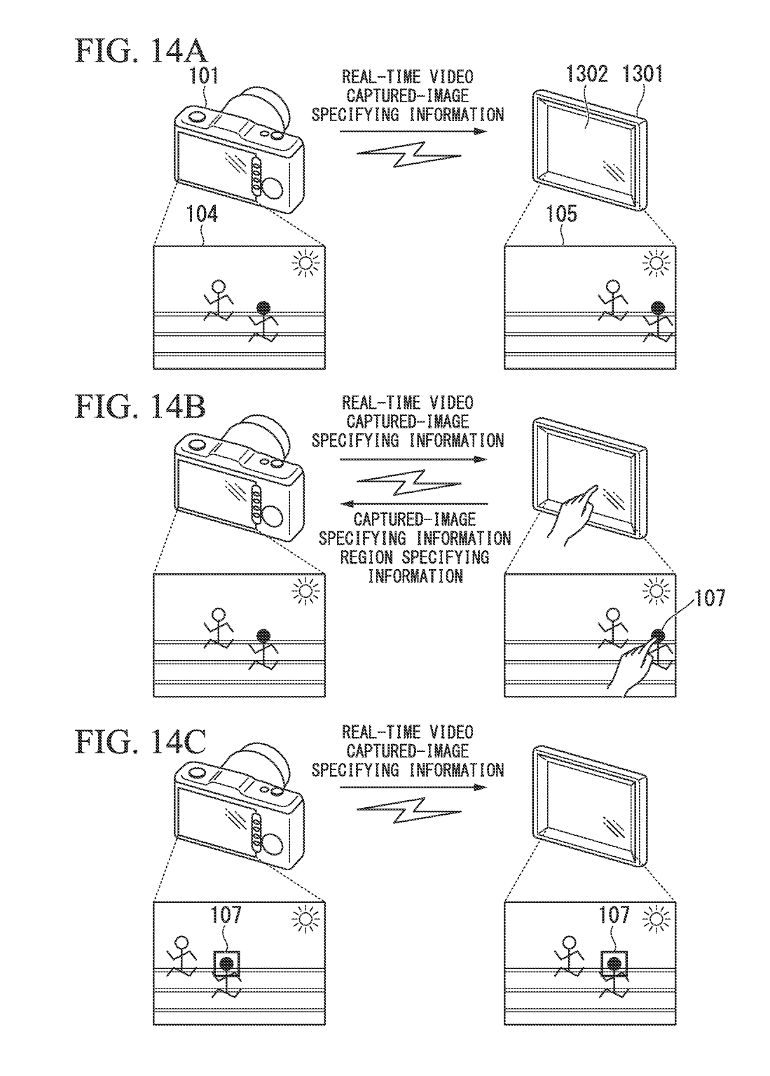

FIGS. 14A to 14C illustrate a flow of all of the operations of a focus adjustment system when the display unit 1302 of the focus instruction device 1301 includes the user interface unit 704. FIG. 14A is the same as FIG. 1A and FIG. 14C is the same as FIG. 1C. In the modified example 4, as illustrated in FIG. 14B, since a user designates a subject by touching a screen while viewing a real-time video displayed on a display unit 1302, an improvement in usability is expected.

### Modified Example 5

For example, in the second embodiment of the present invention, a focus instruction device 1501 may perform a subject detection process and generate a face region of a subject as region specifying information.

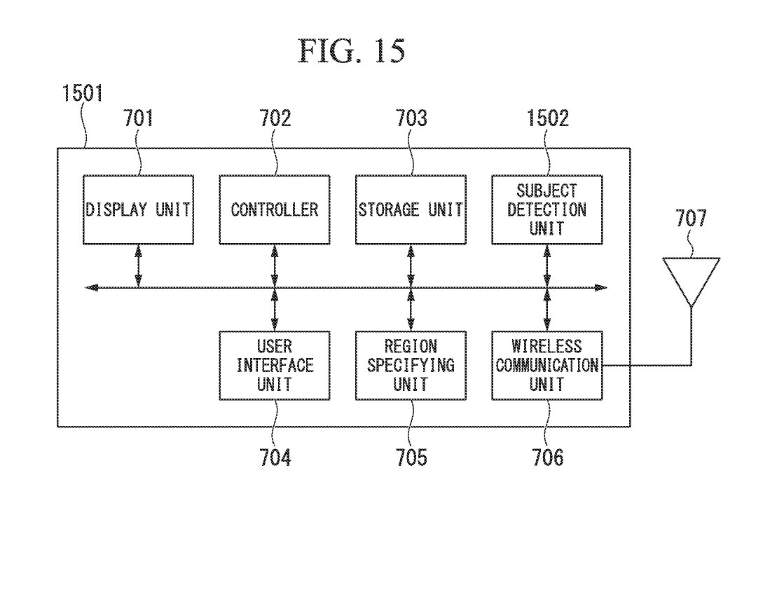

FIG. 15 illustrates the configuration of the focus instruction device 1501 according to the modified example 5. In the focus instruction device 1501, a subject detection unit 1502 detecting a subject at predetermined coordinates of an image is added to the configuration of the focus instruction device 102 illustrated in FIG. 7.

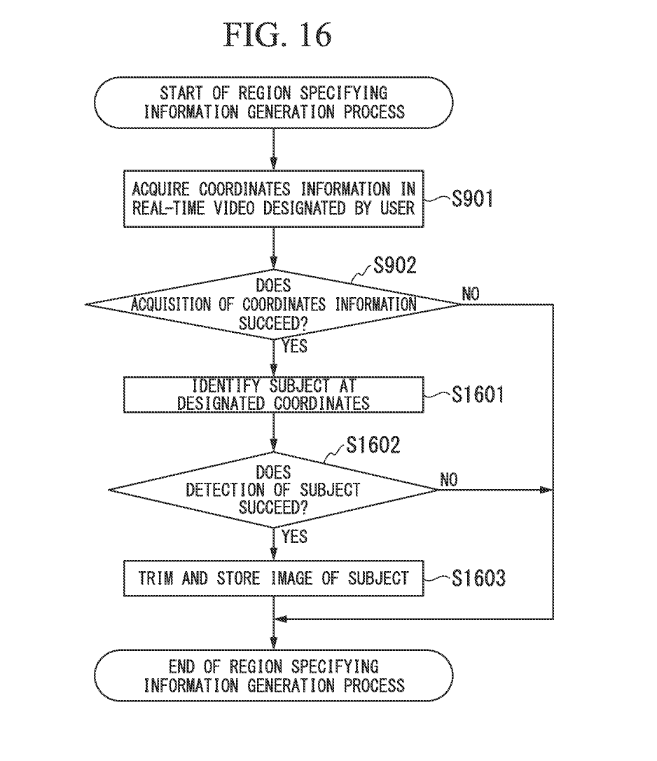

FIG. 16 illustrates a region specifying information generation process according to the modified example 5. The region specifying information generation process according to the modified example 5 will be described with reference to FIG. 16.

As in the region specifying information generation process illustrated in FIG. 9, the region specifying unit 705 acquires coordinates designated by the user in the real-time video in steps S901 and S902. When the acquisition of the coordinates succeeds, the region specifying unit 705 controls the subject detection unit 1502 such that the subject detection unit 1502 detects a subject present at the acquired coordinates (step S1601). In step S1601, the subject detection unit 1502 detects a predetermined subject (for example, a face) from the position designated at the acquired coordinates in the captured image being displayed on the display unit 701.

The region specifying unit 705 detects the subject in step S1601 and subsequently determines whether the detection of the subject succeeds by controlling the subject detection unit 1502. When the detection of the subject succeeds, the region specifying unit 705 causes the process to proceed to a subject image trimming process shown in step S1603. When the detection of the subject fails, the region specifying unit 705 issues, to the controller 202, a region specifying information generation process completion notification including region specifying result information indicating that the specification of the region fails and ends the region specifying information generation process (step S1602).

When the region specifying unit 705 determines that the detection of the subject succeeds in step S1602, the region specifying unit 705 cuts out a face image of the detected subject from the captured image and stores the face image in the storage unit 703. In this case, the region specifying unit 705 issues, to the controller 202, a region specifying information generation process completion notification including region specifying result information indicating that the specification of the region succeeds and the face image of the subject cut out from the captured image and ends the region specifying information generation process (step S1603).

The face image of the subject shown in the modified example 5 may be processed through compression, reduction, or the like after the cutting. The processed face image (compressed image, a reduced image, or the like) of the subject may be applicable as region specifying information.

### Modified Example 6

In the modified example 5, for example, a movement vector of a subject may be calculated using the subject detection unit 1502, and coordinates information and a movement vector may be generated as region specifying information instead of the face image of the subject.

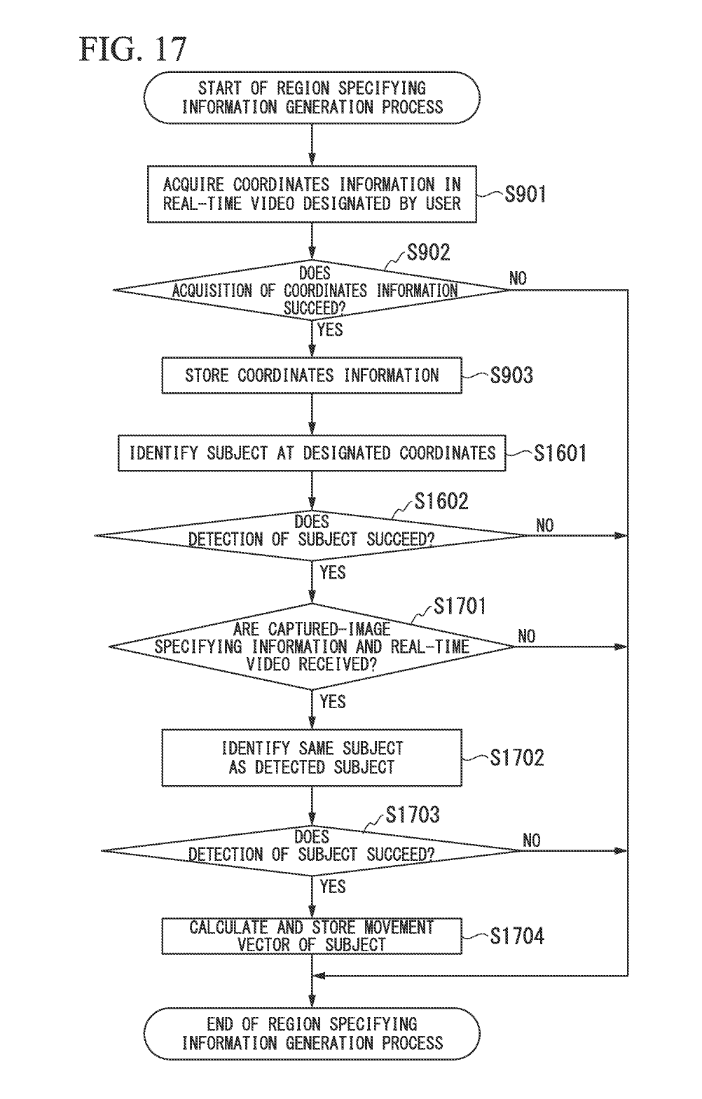

FIG. 17 illustrates a region specifying information generation process according to the modified example 6. The region specifying information generation process according to the modified example 6 will be described with reference to FIG. 17. The region specifying unit 705 stores coordinates information in step S903, as in the region specifying information generation process illustrated in FIG. 9. The region specifying unit 705 stores the coordinates information and subsequently controls the subject detection unit 1502 such that the subject detection unit 1502 detect a subject present at the stored coordinates, as in steps S1601 and S1602 of the region specifying information generation process according to the modified example 5. The region specifying unit 705 detects the subject and subsequently determines whether the detection of the subject succeeds.

When the detection of the subject succeeds, the region specifying unit 705 waits to receive the captured-image specifying information and the real-time video, as shown in step S1701. When the detection of the subject fails, the region specifying unit 705 issues, to the controller 702, a region specifying information generation process completion notification including region specifying result information indicating that the specification of the region fails and ends the region specifying information generation process.

When the region specifying unit 705 determines that the detection of the subject succeeds in step S1602 of FIG. 17, the region specifying unit 705 waits to receive the real-time video and the subsequent captured-image specifying information transmitted from the imaging device 101. When the region specifying unit 705 receives the captured-image specifying information and the real-time video within a predetermined period, the region specifying unit 705 performs a subject detection process shown in step S1702. When the region specifying unit 705 does not receive the captured-image specifying information and the real-time video within the predetermined period, the region specifying unit 705 issues, to the controller 202, a region specifying information generation process completion notification including region specifying result information indicating that the specification of the region fails and ends the region specifying information generation process (step S1701).

When the region specifying unit 705 receives the captured-image specifying information and the real-time video from the imaging device 101 in step S1701, the region specifying unit 705 controls the subject detection unit 1502 such that the subject detection unit 1502 detects the same subject as the subject detected in steps S1601 and S1602 in the received real-time video (step S1702). For example, when the subject is a face, the subject detection unit 1502 detects the same face as the face detected in steps S1601 and S1602 from the captured image received in step S1701 using pattern matching.

After the subject is detected in step S1702, the region specifying unit 705 determines whether the detection of the subject succeeds. When the detection of the subject succeeds, the region specifying unit 705 performs a process of calculating a movement vector of the subject, as shown in step S1704. When the detection of the subject fails, the region specifying unit 705 issues, to the controller 202, the region specifying information generation process completion notification including the region specifying result information indicating that the specification of the region fails and ends the region specifying information generation process (step S1703).

When the region specifying unit 705 determines that the detection of the subject succeeds in step S1703, the region specifying unit 705 calculates a difference between the position which is stored in step S903 and at which the subject is present in the captured image in the previous frame period and the position which is detected in step S1702 and at which the same subject as the captured image of the current frame period is present. The region specifying unit 705 calculates the movement vector of the subject by calculating the above-described difference and stores the movement vector in the storage unit 703 (step S1704). The region specifying unit 705 calculates the movement vector of the subject in step S1704, subsequently issues, to the controller 202, a region specifying information generation process completion notification including region specifying result information indicating that the specification of the region succeeds, the coordinates information of the subject stored in step S903, and the movement vector of the subject calculated in step S1704, and ends the region specifying information generation process.

### Modified Example 7

For example, the above-described the modified examples 5 and 6 may be combined.

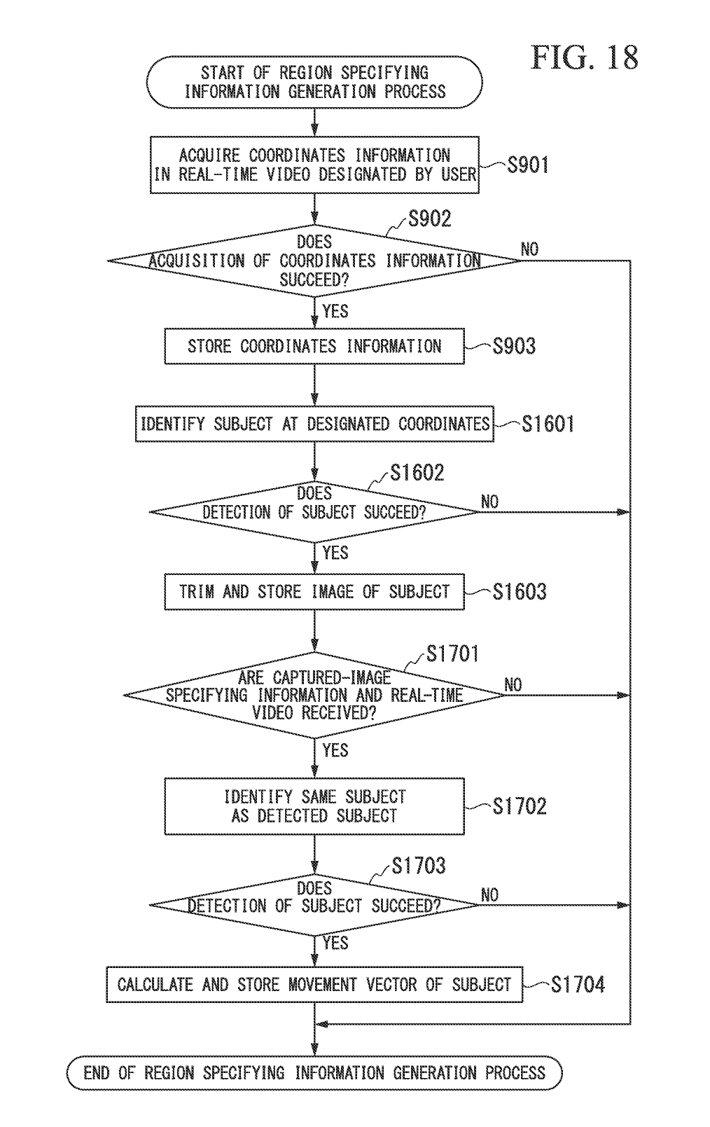

FIG. 18 illustrates a region specifying information generation process according to a modified example 7. The region specifying information generation process according to the modified example 7 will be described with reference to FIG. 18. In FIG. 18, when it is determined in step S1703 that the detection of the subject succeeds, a face image of the subject and a movement vector of the subject are issued as the region specifying information generation process completion notification to the controller 702. Thus, the plurality of technologies disclosed in the embodiments and the modified examples of the present invention may be used in combination.

The embodiments of the present invention have been described in detail with reference to the drawings. However, specific configurations are not limited to the foregoing embodiments and design changes or the like within the scope of the present invention without departing from the scope of the present invention are included.

While preferred embodiments of the present invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An imaging device comprising:
an imaging unit configured to repeat image capturing and output captured images in sequence;
a wireless communication unit configured to wirelessly transmit the captured images in sequence and wirelessly receive a first information specifying one of the captured images wirelessly transmitted in sequence and a second information indicating a specific position or region in the captured image specified by the first information;
a subject detection unit configured to detect a subject present at the position or region indicated by the second information in the captured image specified by the first information, from the captured image newly captured by the imaging unit; and
a focus adjustment unit configured to adjust focus so that the subject detected by the subject detection unit is in focus.

2. The imaging device according to claim 1,
wherein the subject detection unit specifies one of the captured images as a second captured image specified by the first information, excluding a first captured image which is the latest captured image, among the captured images already captured by the imaging unit when the first information and the second information are received,
the subject detection unit detects the subject present at the position or region indicated by the second information in the specified second captured image, subsequently detects the subject detected from the second captured image in a third captured image which is captured between the second captured image and the first captured image, and detects the subject detected from the third captured image in the first captured image, and
the focus adjustment unit adjusts the focus so that the subject detected from the first captured image by the subject detection unit is in focus.

3. The imaging device according to claim 2, wherein the subject detection unit detects the subject in a sequential order in a plurality of the third captured images which are captured between the second captured image and the first captured image.

4. The imaging device according to claim 3, wherein the subject detection unit detects the subject in a sequential order in all of the third captured images captured between the second captured image and the first captured image.

5. The imaging device according to claim 4, wherein the subject detection unit skips some captured images when proceeding among all of the third captured images captured from the second captured image to the first captured image and detects the subject in a sequential order in the third captured images excluding the skipped third captured images.

6. The imaging device according to claim 5, wherein, when the subject detection unit detects the subject in the third captured images in a sequential order, the subject detection unit calculates a movement amount of the subject between the captured images in which the subject is detected and decides a number of the captured images skipped when proceeding from the captured image in which the subject is already detected to the captured image in which the subject is subsequently detected based on the movement amount.

7. The imaging device according to claim 1,
wherein the subject detection unit specifies any of the captured images as a second captured image specified by the first information, excluding a first captured image which is the latest captured image, among the captured images already captured by the imaging unit when the first information and the second information are received,
the subject detection unit detects the subject present at the position or region indicated by the second information in the specified second captured image and subsequently detects the subject detected from the second captured image in the first captured image, and
the focus adjustment unit adjusts the focus so that the subject detected from the first captured image by the subject detection unit is in focus.

8. The imaging device according to claim 1,
wherein the wireless communication unit wirelessly receives a movement vector of a subject present at the specific position or region indicated by the second information,
the subject detection unit estimates, by using the movement vector, a position or region in the captured image newly captured by the imaging unit, the estimated position or region corresponding to the specific position or region indicated by the second information in the captured image specified by the first information, and
the subject detection unit detects the subject present in the estimated position or region.

9. The imaging device according to claim 8,
wherein the subject detection unit calculates a difference amount between frame periods of the captured image specified by the first information and the captured image newly captured by the imaging unit,
the subject detection unit estimates, by using the movement vector and the difference amount between the frame periods, the position or region in the captured image newly captured by the imaging unit, the estimated position or region corresponding to the specific position or region indicated by the second information in the captured image specified by the first information, and
the subject detection unit detects the subject present in the estimated position or region.

10. The imaging device according to claim 1, wherein the wireless communication unit wirelessly receives, as the second information, coordinates information indicating the specific position or region in the captured image specified by the first information.

11. The imaging device according to claim 1, wherein the wireless communication unit wirelessly receives, as the second information, image information regarding the specific position or region in the captured image specified by the first information.

12. The imaging device according to claim 11, wherein the image information is a contracted image of the specific position or region in the captured image specified by the first information.

13. A focus adjustment system comprising:
an imaging unit configured to repeat image capturing and output captured images in sequence;
a first wireless communication unit configured to wirelessly transmit the captured images in sequence;
a second wireless communication unit configured to wirelessly receive the captured images wirelessly transmitted in sequence from the first wireless communication unit in sequence; and
a specifying unit configured to specify one of the captured images wirelessly received in sequence by the second wireless communication unit and specify a specific position or region in the specified captured image,
wherein the second wireless communication unit wirelessly transmits first information indicating the captured image specified by the specifying unit and second information indicating the position or region specified by the specifying unit,
the first wireless communication unit wirelessly receives the first information and the second information, and
the focus adjustment system further comprises:
a subject detection unit configured to detect a subject present at the position or region indicated by the second information in the captured image specified by the first information, from the captured image newly captured by the imaging unit; and
a focus adjustment unit configured to adjust focus so that the subject detected by the subject detection unit is in focus.

14. The focus adjustment system according to claim 13, wherein the second wireless communication unit transmits a frame number as the first information.

15. The focus adjustment system according to claim 13, wherein the second wireless communication unit transmits, as the second information, coordinates information indicating the position or region specified by the specifying unit or image information regarding the position or region.

16. The focus adjustment system according to claim 15, wherein the second wireless communication unit transmits, as the second information, a movement vector of the subject present at the position or region in addition to the coordinates information and the image information.

17. A focus instruction device comprising:
a wireless communication unit configured to wirelessly receive captured images, repeatedly captured by an imaging device and wirelessly transmitted in sequence, in sequence;
a specifying unit configured to specify one of the captured images wirelessly received in sequence by the wireless communication unit and specify a specific position or region in the specified captured image,
wherein the wireless communication unit wirelessly transmits, to the imaging device, first information indicating the captured image specified by the specifying unit and second information indicating the position or region specified by the specifying unit.
